(19) United States
(12) Patent Application Publication
(10) Pub. No.: US 2019/0087145 A1
(43) Pub. Date: Mar. 21, 2019

(54) CONTEXTUAL PRESENTATION SYSTEM

(71) Applicant: Dronicar Inc., Yorktown, VA (US)

(72) Inventors: Yeonjoon Park, Yorktown, VA (US); Bryan Petty, Poquoson, VA (US); Yeon Tae Chung, Atlanta, GA (US); Rachel McCown, Fredericksburg, VA (US)

(21) Appl. No.: 16/136,234

(22) Filed: Sep. 19, 2018

Related U.S. Application Data
(60) Provisional application No. 62/560,505, filed on Sep. 19, 2017.

(51) Int. Cl. G06F 3/147; G06K 9/00; B64C 39/02; G01S 19/45

(52) U.S. Cl. CPC G06F 3/147; G06K 9/0063; G06K 9/00369; B64C 39/024; B64C 2201/12; B64C 2201/024; B64C 2201/021; B64C 2201/022; B64C 39/022; G01S 19/45

(57) ABSTRACT

A contextual presentation system is disclosed. The contextual presentation system may include a communication device. Further, the communication device may be configured for receiving the at least one presentation content from an external content providing device. Further, the contextual presentation system may include a storage device configured for storing each of at least one presentation content and at least one presentation criteria. Further, the contextual presentation system may include at least one sensor configured for sensing at least one contextual data associated with the contextual presentation system. Further, the contextual presentation system may include a processing device communicatively coupled with each of the communication device, the storage device and the at least one sensor. Further, the contextual presentation system may include at least one presentation device configured for presenting the at least one presentation content based on the analyzing.

The current application claims a priority to the U.S. Provisional Patent application Ser. No. 62/560,505 filed on Sep. 19, 2018.

### FIELD OF THE INVENTION

The present disclosure relates generally to the field of presenting information. More specifically, the present disclosure relates to a position, orientation, and situation dependent display system.

### BACKGROUND OF THE INVENTION

In order to communicate with large groups of people, many systems are commonly employed. For advertisements, common methods include flyers, billboards, illuminated displays, shifting monitor displays, and more. Similar methods are commonly utilized to provide publicly necessary information, such as maps or other signage, in highly populated areas. The most convenient way of communicating information to a crowd is often by presenting the information on a flat surface in a visible location. To be visible, information is generally mounted at high traffic areas at some height above the ground.

The convention means of communicating advertisements and other information is therefore highly limited by its geolocation. Advertisements are often static, presenting information at a given height that does not change or adapt to crowd sizes or types. The content of immobile displays may in some cases be changed periodically or sequentially, but still generally result in a stationary display with repeated contents. The message supports take up space on the ground or on a building, which could otherwise be better utilized.

Therefore, there is a need for improved methods and systems to efficiently display information to audiences that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

According to some embodiments, a contextual presentation system is disclosed. The contextual presentation system may include a communication device. Further, the communication device may be configured for receiving the at least one presentation content from an external content providing device. Further, the contextual presentation system may include a storage device configured for storing each of at least one presentation content and at least one presentation criteria. Further, the contextual presentation system may include at least one sensor configured for sensing at least one contextual data associated with the contextual presentation system. Further, the contextual presentation system may include a processing device communicatively coupled with each of the communication device, the storage device and the at least one sensor. Further, the processing device may be configured for analyzing the at least one contextual data and the at least one presentation criteria. Further, the contextual presentation system may include at least one presentation device configured for presenting the at least one presentation content based on the analyzing. Further, the at least one presentation device may be communicatively coupled to the processing device.

Further, according to some embodiments, a contextual presentation system comprising a vehicle is also disclosed. The vehicle may be configured for providing locomotion to the contextual presentation system. Further, the contextual presentation system may include a storage device configured for storing each of at least one presentation content and at least one presentation criteria. Further, the contextual presentation system may include at least one sensor configured for sensing at least one contextual data. Further, the contextual data may include one or more of a position of the vehicle, an orientation of the vehicle, a current way-point associated with a trajectory of the vehicle and a distance travelled by the vehicle from a reference location. Further, the contextual presentation system may include a processing device communicatively coupled with each of the storage device and the at least one sensor. Further, the processing device may be configured for analyzing the at least one contextual data and the at least one presentation criteria. Further, the contextual presentation system may include at least one presentation device configured for presenting the at least one presentation content based on the analyzing. Further, the at least one presentation device may be communicatively coupled to the processing device.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of a contextual presentation system in accordance with some embodiments.

FIG. 3 is a perspective of the contextual presentation system of FIG. 1 in accordance with an exemplary embodiment.

FIG. 4 is a block diagram of the contextual presentation system of FIG. 1 in accordance with further embodiments.

FIG. 5 is a block diagram of a contextual presentation system in accordance with some embodiments.

FIG. 6 is a front right corner perspective view of a quadcopter Unmanned Aerial System (UAS) with dual displays such as flat panel displays or screens with projectors, in accordance with an exemplary embodiment.

FIG. 7 is a front view of the quadcopter drone of FIG. 6.

FIG. 8 is a right side view of the quadcopter drone of FIG. 6.

FIG. 9 is a top view of the quadcopter drone of FIG. 6.

FIG. 10 is a front right corner perspective view of an unmanned airship drone and dual flat panel displays, in accordance with an exemplary embodiment.

FIG. 11 is a front view of the unmanned airship drone of FIG. 10.

FIG. 12A shows a mobile UAS with two displays in accordance with an exemplary embodiment.

FIG. 12B shows a mobile UAS with a double-sided screen with two viewing surfaces in accordance with an exemplary embodiment.

FIG. 13 shows two mobile UAS with dual displays flying inside a sports stadium facing two different audiences, in accordance with an exemplary embodiment.

FIG. 14 shows two mobile flying over two roads with traffic moving in opposite directions, in accordance with an exemplary embodiment.

FIG. 15 is a flow chart of a method corresponding to a displaying algorithm based on geolocation and orientation data, in accordance with some embodiments.

FIG. 16A is a graph with a line that passes through two points in accordance with some embodiments.

FIG. 16B is a graph with a triangular viewing area criteria defined with three line-equations in accordance with some embodiments.

FIG. 17 is a flow chart of a method for determining a specific audience's position in accordance with some embodiments.

FIG. 18 shows a mobile UAS with two displays fly over a predefined path near three groups of audiences in accordance with an exemplary embodiment.

FIG. 19 is a perspective view of a cylindrical coordinate system, where a viewing area or viewing volume can be defined with cylindrical coordinates.

FIG. 20 is a perspective view of a spherical coordinate system, where a viewing area or viewing volume can be defined with spherical coordinates.

FIG. 21 is a top view of an exemplary viewing area which is defined with cylindrical coordinates in accordance with an exemplary embodiment.

FIG. 22 is a perspective view of a general rotation of a mobile UAS in accordance with an exemplary embodiment.

FIG. 23 is a side view of a UAS mounted camera reading QR code on the ground in accordance with an exemplary embodiment.

FIG. 24 is a top view of a mobile UAS communicating with a server on the ground to determine the averaged central position of each group of audiences in accordance with an exemplary embodiment.

FIG. 25 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of presenting information, embodiments of the present disclosure are not limited to use only in this context.

### Overview

According to some embodiments, the present disclosure relates generally to an information display system mounted on a flying machine. More specifically, the disclosed display system for unmanned aerial system (UAS) is a means of displaying geolocation-and-orientation-based interactive information, images and multimedia to people within crowds and populated areas, thus enabling advertisements, maps, entertainment, event announcement, sports score, traffic information and more to be displayed while flying without consuming much ground space.

The disclosed position, orientation and situation dependent display system for unmanned aerial system (UAS) is a set of displays, including various monitors, projectors, and other illuminated screens, mounted to an unmanned aircraft such as a multi-copter drone or an airship. The unmanned aircraft can be any of a variety of airborne support means, including multi-propeller copters, fixed wing Unmanned Aerial Vehicle (UAV), manned or unmanned airship, balloon-based aerostat, and more. The given structure utilizes a series of sensors to determine aircraft orientation, geolocation position, and distance vector relative to groups of people. This data can then be utilized to change the image size and content accordingly, as well as to adjust the position of the aircraft to maximize content readability and visibility. The disclosed hardware and algorithm with Global Navigation Satellite System (GNSS) such as GPS and Inertial Measurement Unit (IMU) sensors enable the system to also be aware of the distance and direction to audience position, the types of audience groups within viewing proximity, and determine whether people are within viewing proximity or not. Correspondingly, the UAS mounted display system changes its multimedia contents, controls the brightness, or deactivates the display device to save energy. Further, an algorithm is disclosed to determine the viewing area of UAS display system to check whether specific audience group can see the display or not.

The disclosed system is configured to display information while moving close to large crowds and audiences without requiring ground space. Further, the disclosed system is a means of creating dynamic messages in which not only the content can be changed, but also the position and orientation of displays mat be changed in response to local and general data, thereby making the information presentation responsive to audience crowd densities and types.

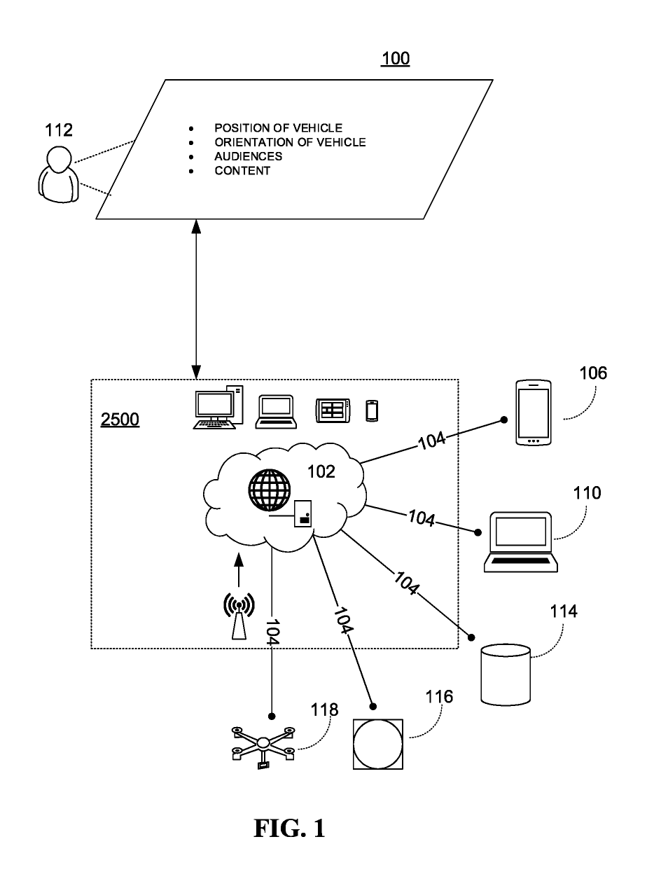

Referring now to figures, FIG. 1 is an illustration of an online platform 100 consistent with various embodiments of the present disclosure. By way of non-limiting example, the online platform 100 to present information may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114 (such as content databases), and sensors 116 (such as a camera sensor,), vehicles 118 (such as a drone) over a communication network 104, such as, but not limited to, the Internet. Further, users of the online platform 100 may include relevant parties such as, but not limited to, viewers, employees at content providing companies, and administrators. Accordingly, in some instances, electronic devices operated by the one or more relevant parties may be in communication with the platform 100.

A user 112, such as the one or more relevant parties, may access online platform 100 through a web-based software application or browser. The web-based software application may be embodied as, for example, but not be limited to, a website, a web application, a desktop application, and a mobile application compatible with a computing device 2500.

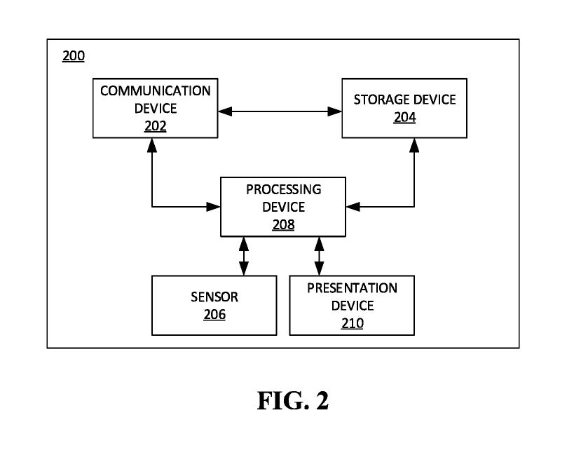

FIG. 2 is a block diagram of a contextual presentation system 200 in accordance with some embodiments. The contextual presentation system 200 may include a communication device 202. Further, the communication device 202 may be configured for receiving the at least one presentation content from an external content providing device. In an embodiment, the external content providing device may be operated by a content administrator, such as, for example, an event manager, an advertiser etc. In another embodiment, the external content providing device may include user devices associated with individual users.

Further, the contextual presentation system 200 may include a storage device 204 configured for storing each of at least one presentation content and at least one presentation criteria. The at least one presentation criteria may include rules that specify what is to be presented, to whom, where, when and how.

Further, the contextual presentation system 200 may include at least one sensor 206 configured for sensing at least one contextual data associated with the contextual presentation system 200.

In some embodiments, the at least one sensor 206 may include a location sensor configured for detecting a geographical location of the contextual presentation system 200 and an orientation sensor configured for detecting an orientation of the contextual presentation system 200 in relation to a reference plane, such as the ground. In further embodiments, the orientation may be a characteristic associated with the presentation device such as a display device. Accordingly, the plane of the display device may be determined to be in one of several possible orientations with respect to a reference place, such as the ground.

In some embodiments, the at least one sensor 206 may include a motion detector configured to detect motion of the contextual presentation system 200. This may include detection of any type of motion (such as translation, rotation, oscillation etc.) and any degree of motion (such as speed, velocity etc.).

In some embodiments, the at least one sensor 206 may be configured for sensing at least one environmental variable associated with an environment surrounding the contextual presentation system 200. This at least one environmental variable may include one or more of ambient light characteristics, ambient sound characteristics, characteristics of objects (e.g. buildings, poles, people) in the vicinity of the contextual presentation system and so on.

In some embodiments, the at least one sensor 206 may include an image capturing device configured for capturing an image. Further, a processing device 208 may be configured for detecting at least one object represented in the image.

Further, the contextual presentation system 200 may include the processing device 208 communicatively coupled with each of the communication device 202, the storage device 204 and the at least one sensor 206. Further, the processing device 208 may be configured for analyzing the at least one contextual data and the at least one presentation criteria. Further, the contextual presentation system 200 may include at least one presentation device 210 configured for presenting the at least one presentation content based on the analyzing. Further, the at least one presentation device 210 may be communicatively coupled to the processing device 208.

In some embodiments, the contextual presentation system 200 may be a vehicle. For example, the vehicle may be one or more of a land vehicle, a water craft, an aerial vehicle and a space vehicle. Further, the contextual data may include one or more of a position of the vehicle, an orientation of the vehicle, a current way-point associated with a trajectory of the vehicle and a distance travelled by the vehicle from a reference location. Further, the reference location may be, for example, an origin location from where the vehicle begins a journey. Alternatively, and/or additionally, the reference location may be a waypoint on the trajectory. Further, in some embodiments, the reference location may be any arbitrary location on the trajectory and/or in the vicinity of the trajectory.

In some embodiments, the at least one object may include a plurality of individuals. Further, the processing device 208 may be further configured for detecting a population size associated with the plurality of individuals.

In some embodiments, the processing device 208 may be configured for detecting at least one demographic characteristic associated with the plurality of individuals.

In some embodiments, the at least one sensor 206 may include a distance sensor configured to measure a distance between the contextual presentation system 200 and the plurality of individuals.

In some embodiments, the processing device 208 may be configured for determining at least one presentation region based on the analyzing of the at least one contextual data.

In some embodiments, the processing device 208 may be configured for determining absence of an individual within the at least one presentation region.

In some embodiments, the processing device 208 may be configured for deactivating the at least one presentation device 210 based on determining the absence of an individual within the at least one presentation region.

In some embodiments, the communication device 202 may be further configured for receiving user data from a plurality of user devices. Further, the user data may include a plurality of locations corresponding to the plurality of user devices.

In some embodiments, the user data further may include a plurality of user preferences corresponding to the plurality of user devices.

In some embodiments, the at least one presentation device 210 may include a plurality of presentation devices configured for presenting a plurality of presentation content to a plurality of presentation regions. For example, the plurality of presentation regions may include a plurality of viewing areas corresponding to a plurality of display devices. Further, a first presentation device of the plurality of presentation devices may be configured for presenting a first presentation content consumable in a first presentation region. Further, a second presentation device of the plurality of presentation devices may be configured for presenting a second presentation content consumable in a second presentation region. Further, the first presentation content may be dissimilar to the second presentation content.

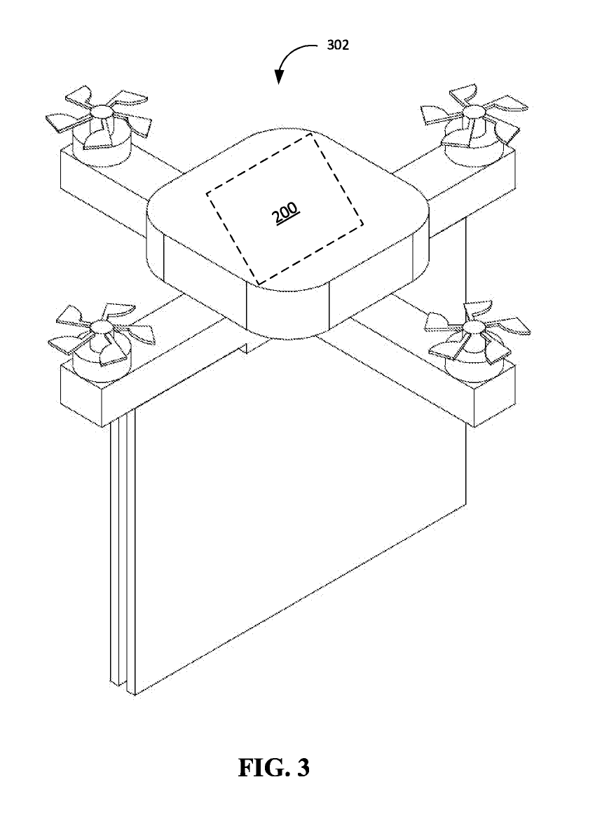

In an exemplary embodiment, the contextual presentation system 200 may be an unmanned aerial vehicle (UAV) 302 as shown in FIG. 3. Accordingly, the contextual presentation system 200 may further include a flight control unit (not shown) communicatively coupled to the processing device 208. Further, the processing device 208 may be further configured for controlling operation of the UAV 302 based on the analyzing.

Further, the processing device 208 may be further configured for controlling one or more of a position, an orientation, a speed, a velocity, an acceleration and a flight path of the UAV 302 in relation to a reference point.

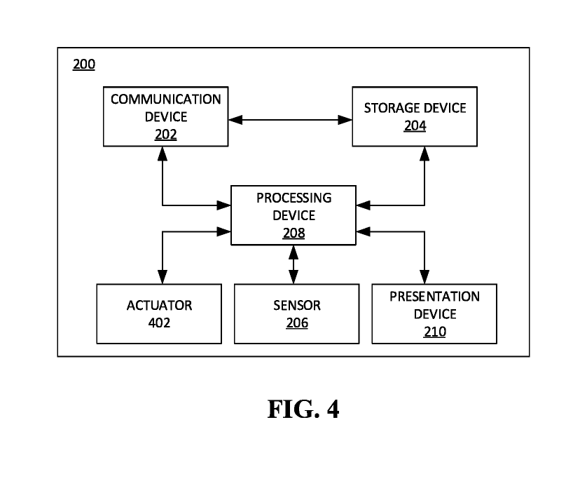

FIG. 4 is a block diagram of the contextual presentation system 200 of FIG. 1 in accordance with further embodiments. The contextual presentation system may further include at least one actuator 402 communicatively coupled to the processing device 208. Further, the at least one actuator 402 may be configured for changing one or more of a position and an orientation of the at least one presentation device 210 in relation to a reference point based on the analyzing.

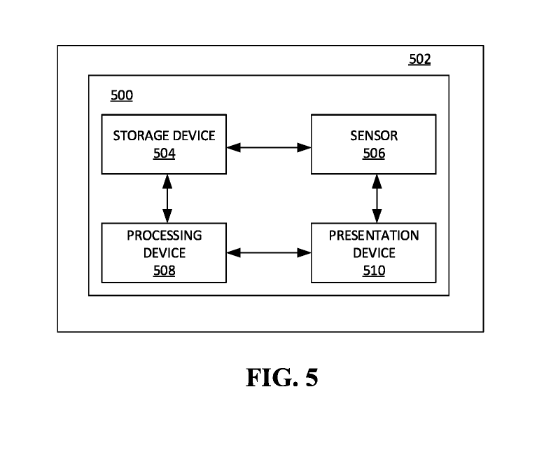

FIG. 5 is a block diagram of a contextual presentation system 500 in accordance with some embodiments. The contextual presentation system 500 comprising a vehicle 502 is also disclosed. The vehicle 502 may be configured for providing locomotion to the contextual presentation system 500. Further, the contextual presentation system 500 may include a storage device 504 configured for storing each of at least one presentation content and at least one presentation criteria. Further, the contextual presentation system 500 may include at least one sensor 506 configured for sensing at least one contextual data. Further, the contextual data may include one or more of a position of the vehicle 502, an orientation of the vehicle 502, a current way-point associated with a trajectory of the vehicle 502 and a distance travelled by the vehicle 502 from a reference location. Further, the contextual presentation system 500 may include a processing device 508 communicatively coupled with each of the storage device 504 and the at least one sensor 506. Further, the processing device 508 may be configured for analyzing the at least one contextual data and the at least one presentation criteria. Further, the contextual presentation system 500 may include at least one presentation device 510 configured for presenting the at least one presentation content based on the analyzing. Further, the at least one presentation device 510 may be communicatively coupled to the processing device 508.

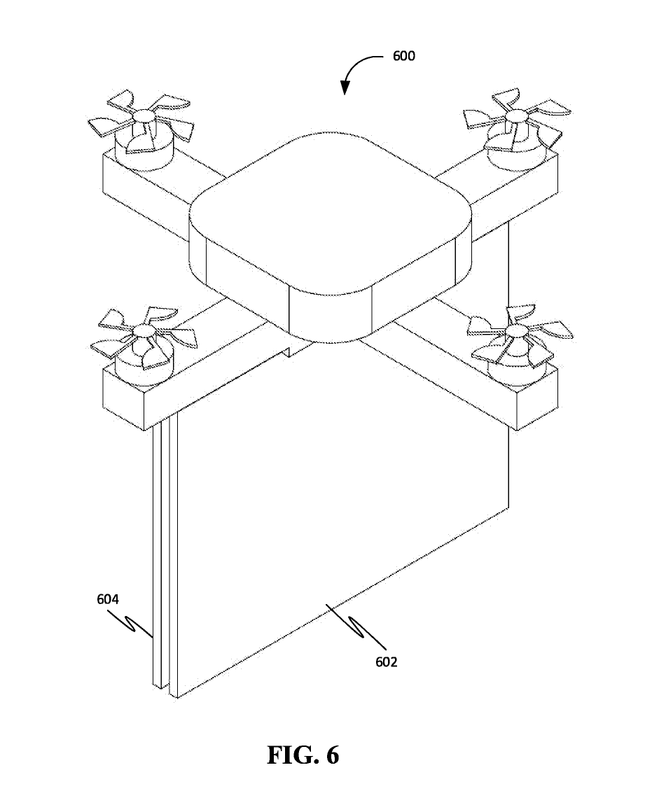

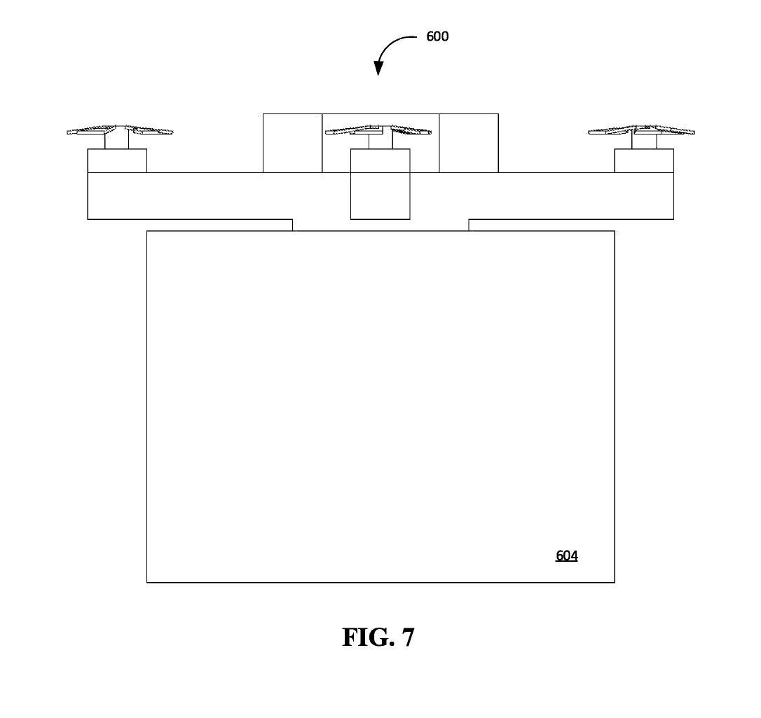

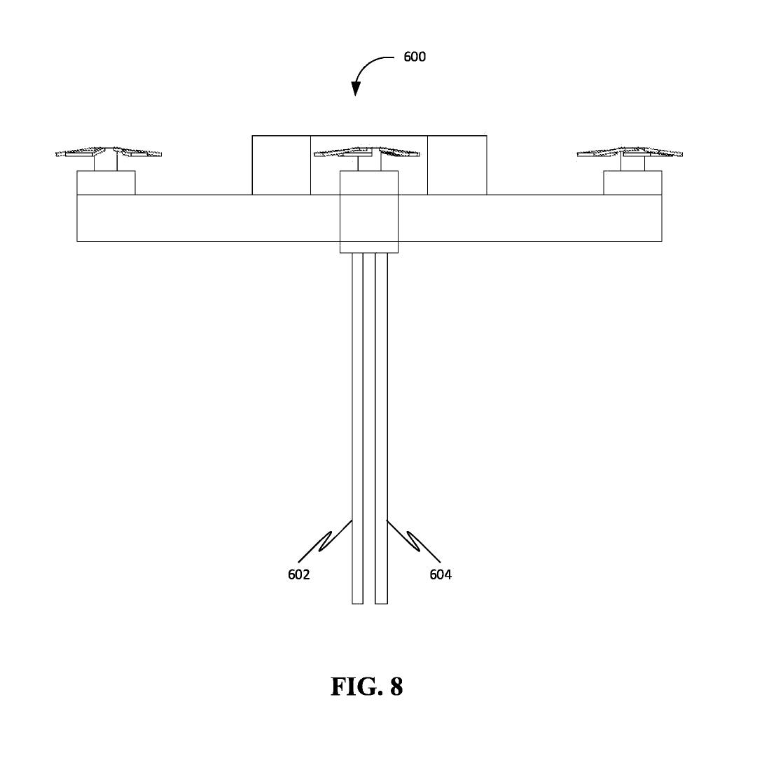

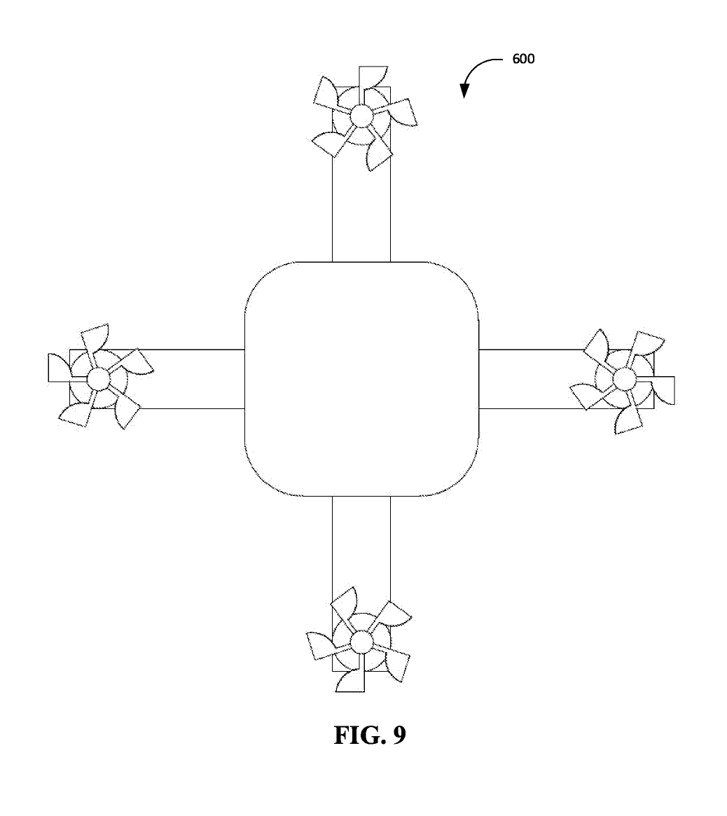

FIG. 6 is a front right corner perspective view of a quadcopter Unmanned Aerial System (UAS) 600 with dual displays 602-604 such as flat panel displays or screens with projectors, in accordance with an exemplary embodiment. FIG. 7 is a front view of the quadcopter drone 600 of FIG. 6. FIG. 8 is a right side view of the quadcopter drone 600 of FIG. 6. FIG. 9 is a top view of the quadcopter drone 600 of FIG. 6.

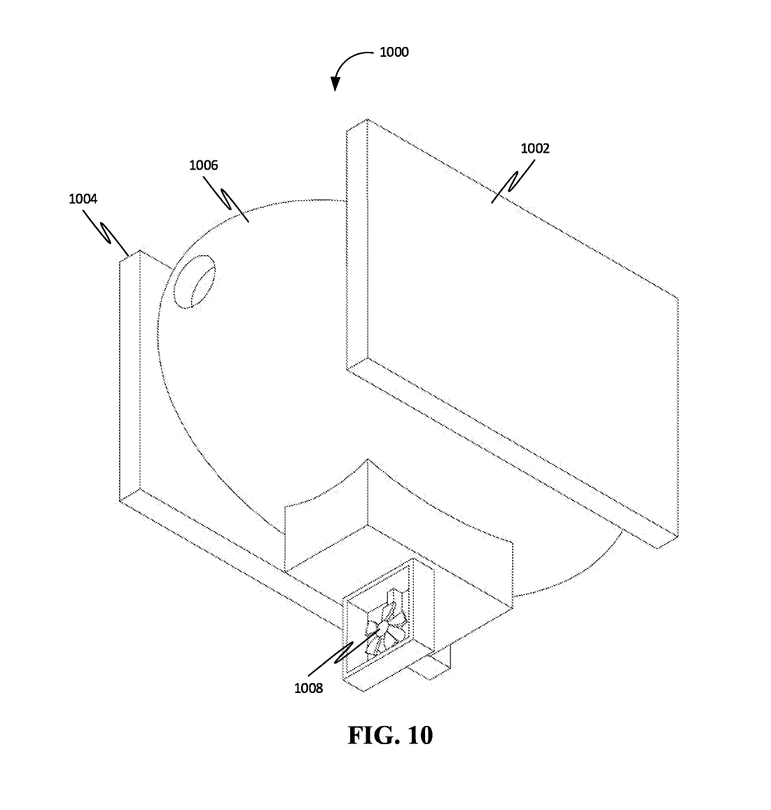

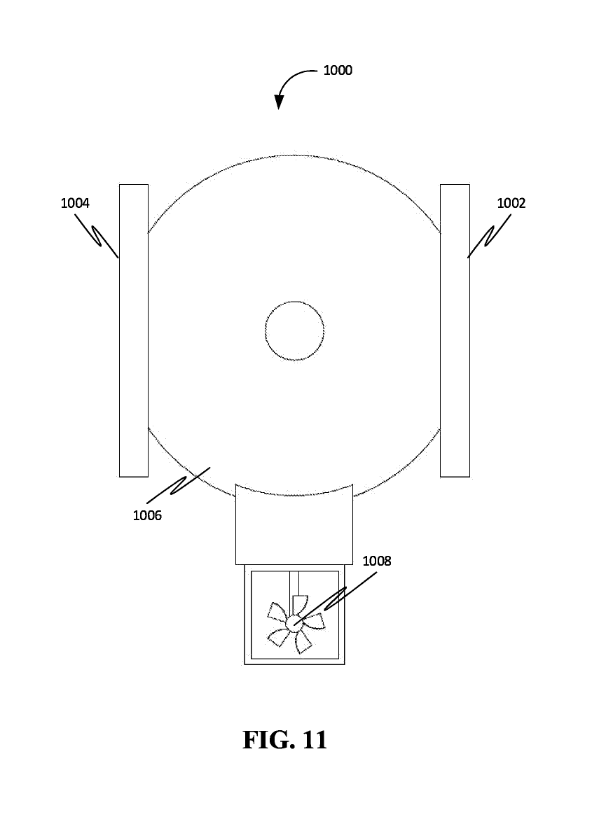

FIG. 10 is a front right corner perspective view of an unmanned airship drone 1000 and dual flat panel displays 1002-1004, in accordance with an exemplary embodiment. FIG. 11 is a front view of the unmanned airship drone 1000 of FIG. 10.

Further, each of the quadcopter Unmanned Aerial System (UAS) 600 and the unmanned airship drone 1000 (hereon referred to as mobile UAS) enables the public display of information, such as advertisements, maps, event information, and more, by flying in public areas without consuming ground space such as a top of a building or a billboard stand.

Further, the mobile UAS may include one or more of a hovering means, a UAV body frame (such as a multi-copter or airship respectively), a flight and display control computer, GNSS & IMU sensor and display equipment such as the flat panel displays 602-604 and 1002-1004. Further, the flat panel displays 602-604 and 1002-1004 may include one or more LCD/LED TV, Organic LED (OLED) TV, e-ink panel, Electro-Luminescence (EL) panel, LED strips and LED image curtain or projectors.

The hovering means may enable the mobile UAS to float, suspended, in place in midair. For example, the hovering means may include a plurality of propellers and a plurality of motors, piston engines, or jet-turbines, as shown in FIGS. 6, 7, 8 and 9. The plurality of motors may include a set of electrical units that convert electrical energy into rotational mechanical energy. The plurality of propellers is a circular pattern of aerodynamically-designed blades that enable conversion of torque from the plurality of motors into a linear propulsion force. Each propeller of the plurality of propellers can be directed in conjunction with the other propellers of the plurality of propellers to control the acceleration in 3D space.

In an alternative embodiment, the hovering means may include a balloon 1006, as shown in FIGS. 10 and 11. The balloon 1006 may be a flexible polymer device that enables the unmanned airship drone 1000 to navigate through the air. Further, the unmanned airship drone 1000 may include at least one balloon (such as the balloon 1006), a propeller 1008, ducted fan or jet-turbine. The propeller, ducted fan, or jet-turbine may be a propulsion means that enables movement direction control of the unmanned airship drone 1000.

Further, the mobile UAS may include a rigid support fuselage frame that provides support to several features, and arrangement of those features relative to the hovering means. Further, the frame may include a power unit, a plurality of sensors, an on-board computer or micro controller unit (MCU), at least one display, and a machine vision camera. The power unit provides electrical power to components as necessary. The power unit comprises a battery, a plurality of solar panels, and a plurality of electrical connections. The battery is an electrical energy storage unit that enables collection and subsequent distribution of electrical power to the various components of the frame. Optionally, a plurality of solar panels can be mounted for a set of energy generation units that convert solar power into electrical power, thus providing a means for replacing energy lost during use of the battery. The plurality of electrical connections is a series of wires, resistors, and other common electrical components that enable connection of the plurality of sensors and the hovering means to the power unit. The plurality of sensors is a set of devices that enable the mobile UAS to respond to changes in its position and in its environment. The plurality of sensors and components comprises at least one local computer like on-board mini-PC or a micro controller unit (MCU), flight support sensor, environment sensor like ambient light detector, a global navigation satellite system, and an inertial measurement unit. Further, each environment sensor provides feedback from the immediate environment of mobile UAS, thus enabling it to respond to those changes, such as ambient light intensity. The at least one local data sensor may include one or more of a camera, an optical sensor, an acoustic sensor, a 2D/3D accelerometer, a 2D/3D gyroscope, and a 2D/3D magnetic compass. The camera enables capture of visual data relating to the proximal audience or environment. The optical sensor is a sensor that can measure distance of a solid object from the optical sensor. The acoustic sensor measures the decibel level of the environment. Data collected from the optical sensor and the acoustic sensor may be used to adjust the distance of the mobile UAS from objects and crowds. The 2D/3D accelerometer is a measurement device that tracks the orientation of the mobile UAS. The gyroscope similarly measures the angular orientation changes of the mobile UAS. Further, the magnetic compass determines overall orientation of the mobile UAS. Collected data from the 2D/3D accelerometer, the gyroscope, and the magnetic compass may be utilized to calibrate and control the balance and heading of the mobile UAS in the air as well as it may determine the viewing area in which the audience may see the display on UAS. The global navigation satellite system (GNSS) including GPS, Globalnaya Navigazionnaya Sputnikovaya Sistema (GLONASS), Galileo, and BeiDou Navigation Satellite System (BDS) is a means of acquiring geolocation data, often in the form of various styles of coordinates, to the computer of the mobile UAS for subsequent interpretation and adjustment. Similarly, the Inertial Measurement Unit (IMU) measures changes in the acceleration, rotation and orientation of the mobile UAS. The inertial measurement unit includes a magnetic sensor. The magnetic sensor is a device which analyzes ambient magnetic field influence. Combined, the global navigation satellite system and the inertial measurement unit provide the computer of the mobile UAS with data regarding the position of the mobile UAS on a global scale, which enables the user to modify the position of the mobile UAS based on coordinates, thereby enabling the mobile UAS to target more densely populated areas during events and the like. The display is at least one screen or generally flat panel display device upon which images may be displayed, such as advertisements, maps, event information, or more, as seen in FIG. 8. The display may include individual or combination of projectors, LED/LCD TVs, LED strip curtain displays, e-ink on e-paper, general illuminated posters, and more. The machine vision camera is a laser device or a computer-connected camera capable of scanning and analyzing barcodes and QR codes. Upon scanning, relevant information may be presented upon the display.

The computer or micro controller unit (MCU) of the mobile UAS is a device capable of storing, interpreting, and processing data collected from the plurality of sensors, and converting data and command signals from the user into responses controlling the at least one display and the hovering means. The computer comprises a wireless transceiver, software, and at least one memory and data storage device. The wireless transceiver is a device capable of sending and receiving information and commands, such as manual position control and content toggling controls, from the user's mobile device or other equipped devices. The software is a set of commands written in any of a variety of programming languages that controls the logic and commands of the mobile UAS, thus enabling the mobile UAS to interpret and transform incident data into signals for use by relevant components. The at least one memory and data storage device is a set of short-term and long-term data storage units with its own set of software commands capable of sending and receiving information to and from the computer of the mobile UAS.

Further, the computer of the mobile UAS acquires a Position, Orientation and Situation data then changes display contents of the display system on the mobile UAS. The user loads display contents data containing visual information to be shown on the at least one data storage unit into the computer or it may be uploaded with wireless communication before or while flying. The user then brings the mobile UAS to an event or public area. The hovering means activates, enabling the mobile UAS to take flight. The display illuminates, showing the message or information uploaded by the user, i.e. remote pilot or by the audience with wireless communications. The mobile UAS utilizes the plurality of sensors to determine crowd data and position data, and adjusts its height and lateral position accordingly. The user may also control the device settings by communicating with the wireless transceiver of the mobile UAS. Upon completion of message delivery of an event, or in general upon completion of use of the mobile UAS, the hovering means guides back to the user. The mobile UAS may be then prepared for subsequent application.

Further, advertisements are often made for a certain demographic and placed in an area or published on different forms of media that will be most effective. The market for a product advertised may be based on specific audience groups at different positions with different ages, ethnicities, preferences, and practices. In situations where an audience may vary in these factors, the advertisement should change depending on what audience's position and attention it is trying to attract.

Further, advertisements at ground level with zero height are not practical for large crowds of people. Billboards are large stationary objects that often cannot be viewed by an entire audience easily, sometimes requiring multiple billboards with the similar advertisements to be displayed. Changing what is being advertised is time consuming and may become outdated quickly. Another popular method is with aerial advertisements. Aerial vehicles have limited advertisement capabilities, though, and have a fixed visual that cannot be changed easily while in flight. Electronic advertisements in the air rely on a fixed timer that may display what the designer chooses in the same rotating pattern.

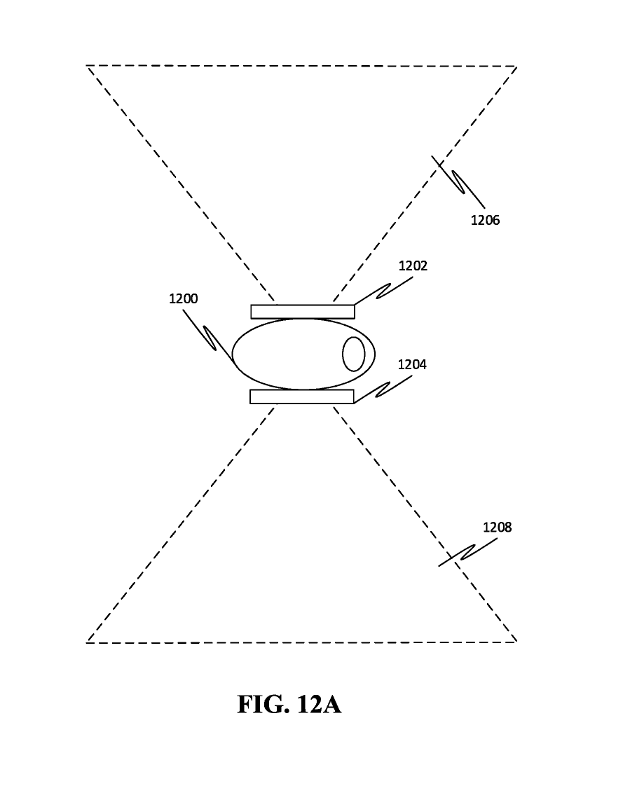

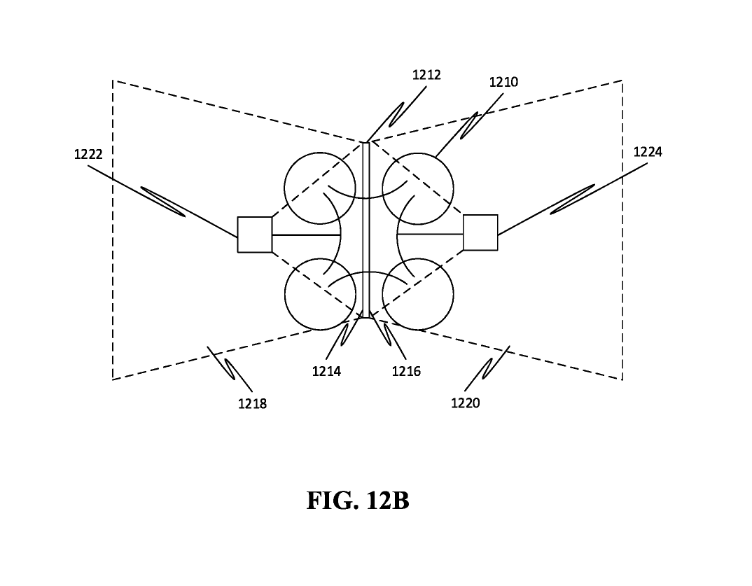

The mobile UAS equipped with a changing visual based on position and orientation may have the mobile ability to address a multitude of people at once and may change what is displayed as its advertisement depending on its geo-position location and cardinal direction, i.e. orientation, as shown in FIGS. 12A-B, 13, 14. The mobile UAS with on-board displays is shown along with viewing areas where the audience may recognize the contents displayed on the displays of the mobile UAS.

Specifically, FIG. 12A shows a mobile UAS 1200 with two displays 1202-1204 in accordance with an exemplary embodiment. Further, each of the two displays 1202-1204 is visible to audiences in viewing areas 1206-1208 respectively. Similarly, FIG. 12B shows a mobile UAS 1210 with a double-sided screen 1212 with two viewing surfaces 1214-1216 in accordance with an exemplary embodiment. Further, each of the two viewing surfaces 1214-1216 is visible to audiences in viewing areas 1218-1220 respectively. Further, the mobile UAS 1210 may include two projectors 1222-1224 for projecting content on the two viewing surfaces 1214-1216 respectively.

The ability of the disclosed mobile UAS to cover a widespread area with its movement may allow many more viewers to see the display. Visuals are often limited to a certain area that may be viewed only by those in its line of sight. The mobile UAS may be seen by more persons and may also be able to adjust its advertisements depending on the crowd or individuals it is near to. This may be useful at a variety of sporting events, to redirect traffic and inform drivers of hazards, or to send differing messages depending on which way the viewer is facing the mobile UAS.

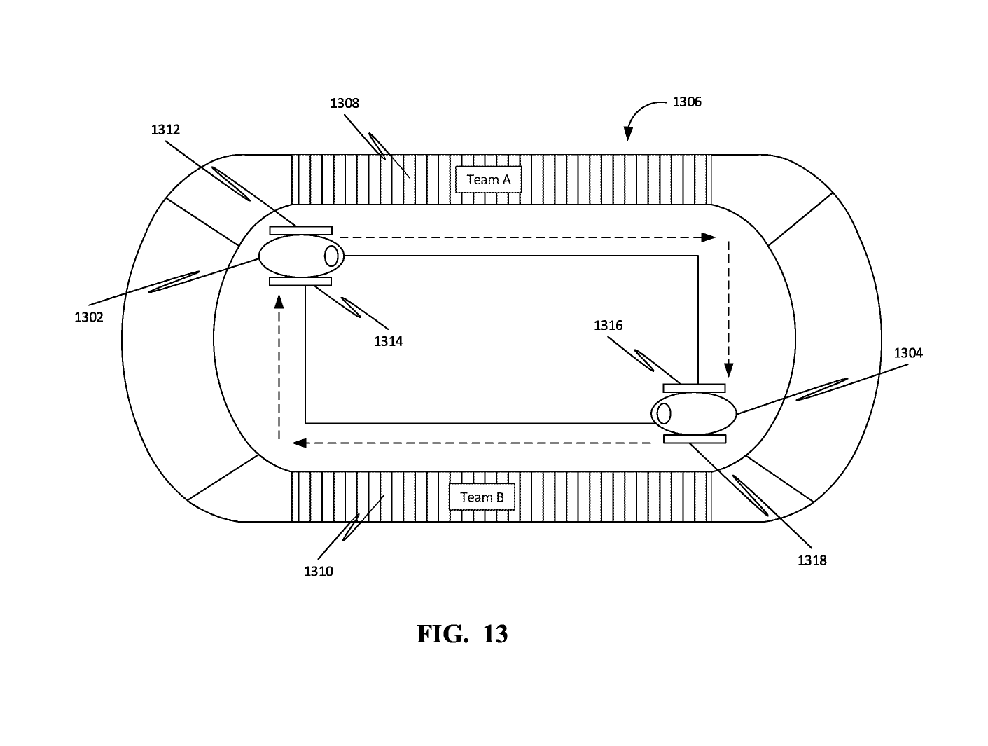

FIG. 13 shows two mobile UAS 1302-1304 with dual displays flying inside a sports stadium 1306 facing two different audiences, including an audience 1308 for a team A and an audience 1310 for a team B, in accordance with an exemplary embodiment. Each display may show the right contents to the right audience (such as the audience 1308 and the audience 1310). Not only the position of each UAS in the two mobile UAS 1302-1304 but also the orientation of each UAS in the two mobile UAS 1302-1304 determines the contents to be displayed. Accordingly, a display 1312 of the mobile UAS 1302 may display content for the team A and a display 1314 of the mobile UAS 1302 may display content for the team B. Similarly, a display 1316 of the mobile UAS 1304 may display content for the team A and a display 1318 of the mobile UAS 1304 may display content for the team B.

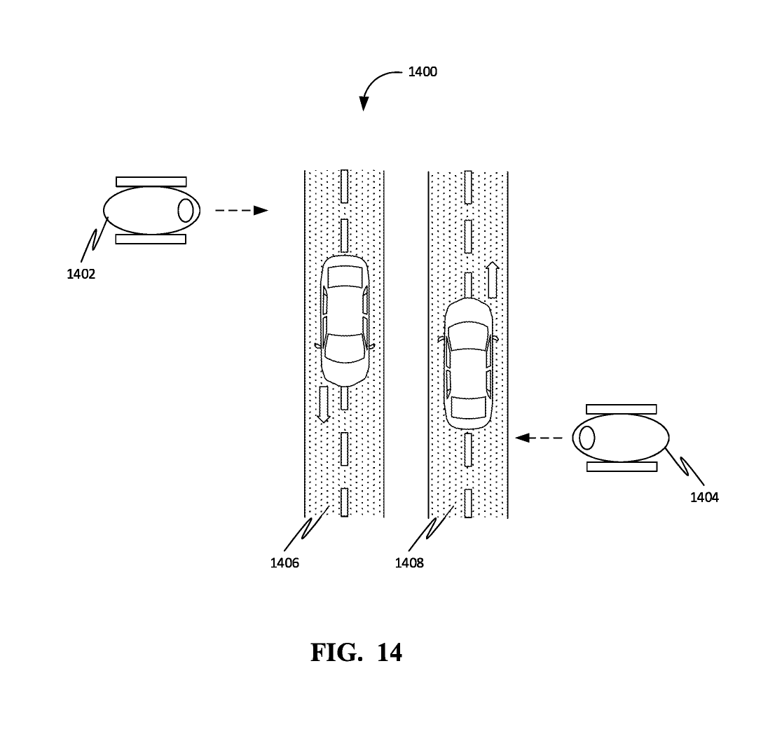

FIG. 14 shows two mobile UAS 1402-1404 flying over two roads 1406-1408 with traffic moving in opposite directions, in accordance with an exemplary embodiment. The displays mounted on the two mobile UAS 1402-1404 is facing cars moving in opposite directions. Accordingly, the content displayed on the displays are chosen for the right audience based on the direction they are moving.

According to some embodiments, the computer on the mobile UAS may be programmed to display images or videos using various programs. A changing display software may utilize a computer implemented algorithm capable of reading Global Navigation Satellite Systems (GNSS, which contains a Global Positioning System) data, as well as an IMU (Inertial Measurement Unit) which has a vision based rotation measurement using 2D/3D accelerometer, gyroscope and magnetic compass, to gather the mobile UAV's current orientation and position. This data may then be used to change the advertisement shown accordingly, changing it based on latitude and longitude, which cardinal direction it is facing, and what orientation the UAS is currently at.

Further, the mobile UAS has mobility and may be able to rotate itself according to what audience or persons the user may like to target. It may use its own battery power and additional external solar panels to power the projector that may run such advertisements and change them for hours at a time.

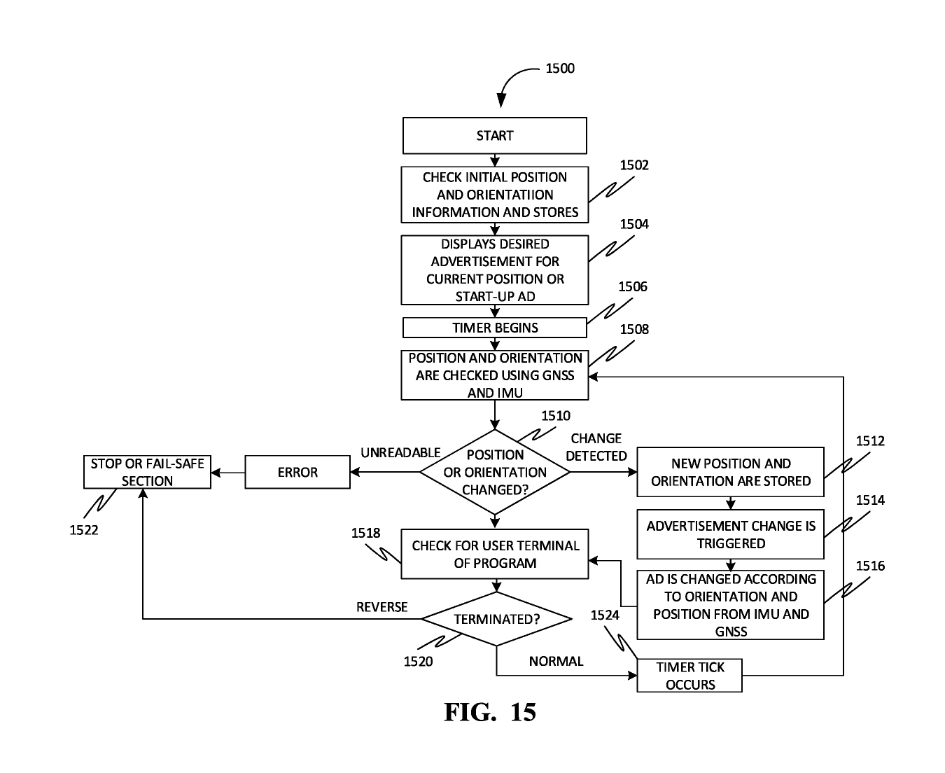

FIG. 15 is a flow chart of a method 1500 corresponding to a displaying algorithm based on geolocation and orientation data obtained from a GNSS sensor and IMU sensor of the mobile UAS, in accordance with some embodiments. The displaying algorithm may run on the attached hardware and may create a running thread for the corresponding program. This thread may control the input of the data and may store it in global variables accessible throughout the class file. Such variables may hold values for the latitude, longitude, cardinal direction, orientation, time stamp, GNSS functionality status, and velocity.

At 1502, the method 1500 may include checking initial position and orientation based on data received from a connected GNSS and IMU. The obtained position and orientation data may be then stored.

At 1504, the method 1500 may include the mobile UAS displaying a desired advertisement (or start-up ad) based on the initial position and orientation.

Then, at 1506, the method 1500 may include initiating a timer. Thereafter, at 1508, the method 1500 may include continuously checking the position and orientation.

Then, at 1510, the method 1500 may include detecting a change in the position and orientation. The detecting may include comparing the current position and orientation against a pre-determined set of coordinates or cardinal direction. If there is a change in the position or orientation, then the method 1500 may go to the step 1512. At 1512, the method 1500 may include storing the new position and orientation. Then, at 1514, the method 1500 may include triggering change of advertisement display by sending a signal to a projector to change the currently displayed advertisement. Further, at 1516, the method 1500 may include changing the displayed advertisement. Thereafter, the method 1500 may go to a step 1518. Further, if change is not detected at 1510, then the method 1500 may go to a step 1518.

At 1518, the method 1500 may include checking if the user terminates the algorithm. The user may be able to end the timer's cycles by interrupting the current timer tick with a check for input. A check may also be performed to assure the algorithm that data is still being read from the GNSS and that the position may be updated. If the GNSS is not functioning or an error occurs while the data is being gathered and processed, then the algorithm is terminated (at 1520) to avoid malfunctions with the UAS and external sensors and the method goes to 1522.

The unexpected situation or error may cause an undetectable malfunction wherein the position is not checked and therefore the advertisement is not changed accordingly. This may defeat the purpose of the algorithm and may render the changing advertisement ineffective. Therefore, it is necessary to perform a check to make sure all connected systems are performing accordingly and updating as needed.

Therefore, if the sensors are functioning correctly and reading in data after the next timer tick then the program will continue to run uninterrupted (goes to step 1524), continuously updating until either an error occurs or the operator intervenes.

The mobile UAS may also change the displayed image and multimedia based on its distance it traveled or distance to the waypoints as well as its orientation. Using GNSS to calculate a travel distance on a predetermined flight path or distance to waypoints, the mobile UAS may display various advertisements based on its orientation during continuous flight or once it reaches certain waypoints on its flight path.

Similarly, the mobile UAS may be able to collect information to determine the orientation of the mobile UAS and whether there is a viewing audience present in the direction that the advertisement is showing. This may be done using sets of coordinates from the GNSS in correlation with the orientation provided by the IMU. For example, the viewing areas 1206-1208 and the viewing areas 1218-1220 shown in FIGS. 12A-B above.

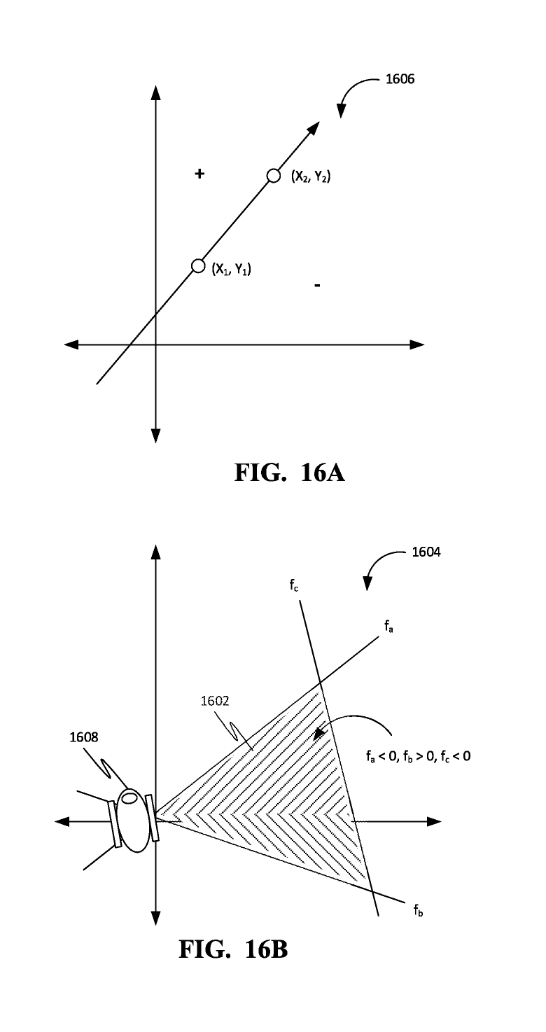

Further, a viewing area (in the viewing areas 1206-1208 and the viewing areas 1218-1220) may be determined by a triangular area or trapezoid area using a set of predetermined coordinates lying along multiple lines on an XY-Plane. For example, a triangular viewing area 1602 (for a mobile UAS 1608) may be defined with three line-equations as shown by a graph 1604 in the FIG. 16B. Using a line formula (refer equation [1] below) for a line that passes through two points (x₁, y₁) and (x₂, y₂), characteristic formula fₐ(x,y) may be defined (refer equation [2] below) as shown in a graph 1606 in FIG. 16A. When fₐ(j,k)=0, the point (j,k) is on the line (refer equation [3] below). If fₐ(j,k)>0 the point (j,k) is above the line (refer equation [4] below) and if fₐ(j,k)<0, the point (j,k) is below the line (refer equation [5] below). Thereafter, the three lines (refer equations [8] below) may be mapped and used to represent zero, or the boundaries of the viewing area. Having an orientation in which the mobile UAS is faced above a line, which are represented as fₐ<0, f_{b}>0, and f_{c}<0. Accordingly, an audience may see the display if the mobile UAS is at the correct set of coordinates and orientation such that the display screens of the mobile UAS are within the determined area.

$$\begin{matrix}\frac{y - {y}_{1}}{x - {x}_{1}} = \frac{{y}_{2} - {y}_{1}}{{x}_{2} - {x}_{1}} & [ 1 ] \\ {f}_{a} ( x , y ) = ( \frac{y - {y}_{1}}{x - {x}_{1}} - \frac{{y}_{2} - {y}_{1}}{{x}_{2} - {x}_{1}} ) & [ 2 ] \\ {f}_{a} ( x , y ) = 0 & [ 3 ] \\ {f}_{a} ( x , y ) > 0 & [ 4 ] \\ {f}_{a} ( x , y ) < 0 & [ 5 ]\end{matrix}$$

Similarly, following line equations 6-7 are obtained.

f_{b}(x, y)=0 [6]

f_{c}(x, y)=0 [7]

fₐ<0,f_{b}>0, f_{c}<0 [8]

Further, the mobile UAS may determine whether the audience is present inside a viewing area so that they may see the display. If there is no audience in the viewing area, the mobile UAS may turn off the display to save energy.

Further, the mobile UAS may be capable of using the calculated distance and angles to adjust the visual's brightness. Not only polygonal lines in the Cartesian coordinates but also a cylindrical or spherical coordinate system may be used to define viewing area efficiently. A viewing area may be divided into sub-areas based on distances and angles from the mobile UAS. Further, different multimedia such as different contents and different shapes and sizes of fonts, symbols, and images may be displayed for each sub-area where the audience points are temporarily located.

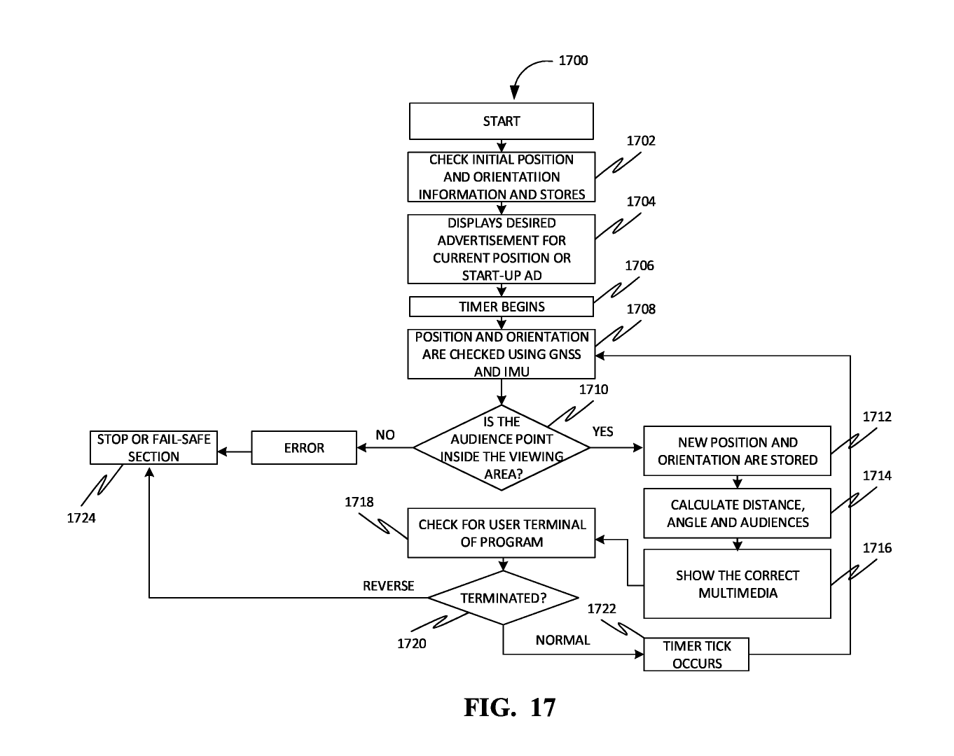

FIG. 17 is a flow chart of a method 1700 for determining a specific audience's position is included inside a viewing area or not. At 1702, the method 1700 may include checking initial position and orientation based on data received from a connected GNSS and IMU. The obtained position and orientation data may be then stored.

At 1704, the method 1700 may include the mobile UAS displaying a desired advertisement (or start-up ad) based on the initial position and orientation.

Then, at 1706, the method 1700 may include initiating a timer. Thereafter, at 1708, the method 1700 may include continuously checking the position and orientation.

At 1710, the method 1700 may include checking if the audience is present inside the viewing area. If it is determined that the audience is present inside the viewing area, then the method 1700 goes to step 1712. At 1712, a new position and orientation of the mobile UAS is stored. Thereafter, at 1714, the method 1700 includes calculating distance and angle of the audiences. Accordingly, at 1716, the method 1700 includes showing the correct multimedia. Further, at 1718, the method 1700 includes checking for user termination of the method 1700. If the termination is not detected at 1720, then the timer tick occurs at 1722 and the method 1700 goes back to step 1708.

However, if the termination is detected at 1720, then the method 1700 goes to 1724 for a stop or fail-safe action.

Further, repetition of the method 1700 is steadily performed for many different audience positions and continuously changing viewing areas on the flight path.

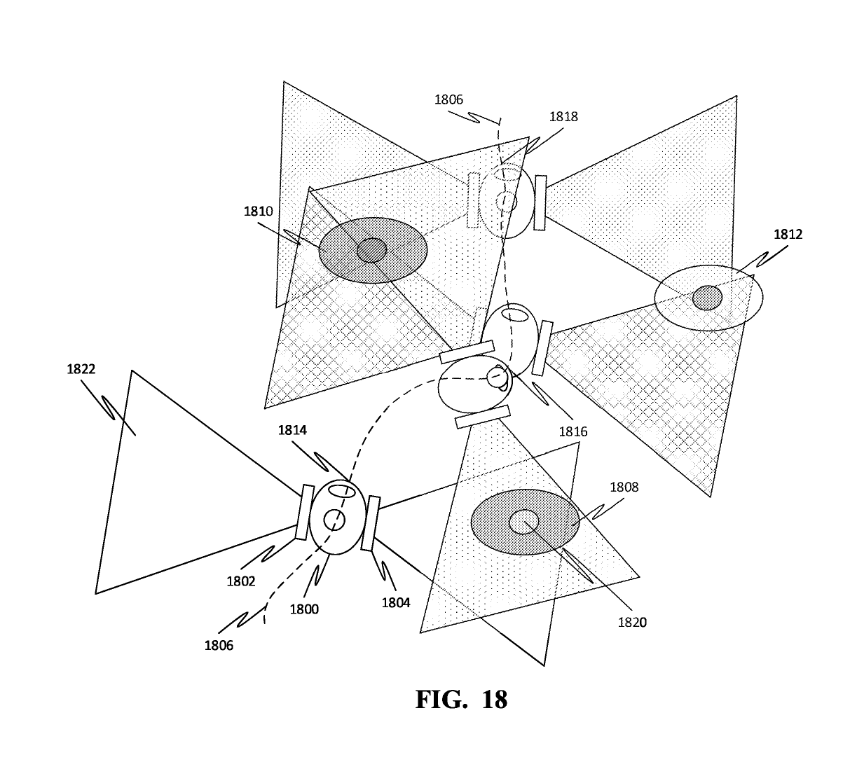

FIG. 18 shows a mobile UAS 1800 with two displays 1802-1804 fly over a predefined path 1806 near three groups of audiences 1808-1812. The path 1806 includes three path points 1814-1818. At the path point 1814, the mobile UAS's 1800 viewing area includes a point 1820 for the audience 1808 only. Accordingly, an image may be displayed on the display 1804 for the audience 1808, but the display 1802 on the left side of the mobile UAS 1800 is turned off to save power because there is no audience in a left viewing area 1822.

The mobile UAS 1800 may then fly to the path point 1816. At the mobile UAS 1800, the mobile UAS 1800 turns its orientation and it may display different contents to each audience in viewing area based on the mobile UAS's 1800 orientation although the mobile UAS's 1800 position may be same. At the path point 1816, before the mobile UAS 1800 makes the turn, the audiences 1808 and 1810 are inside the viewing areas so images may be displayed on the both displays 1802-1804.

At the path point 1816, after the mobile UAS 1800 makes the turn, the audience 1808 is excluded and the audience 1812 is included in the viewing areas so images may be displayed on the both displays 1802-1804. Different images may be displayed to the different audiences. Then, at the path point 1818, the mobile UAS 1800 may show the same images as the audiences 1810-1812 are still included in the viewing areas.

The conventional fixed billboards and other display devices may rotate through advertisements based on an elapsed amount of time. However, they change solely on the fact that a certain period of time has passed. The disclosed systems and method may also consider the positioning and orientation of the mobile UAS and may be pre-programmed for determining how the advertisement may change and what it may change to. Further, the disclosed systems and method also utilize data gathering sensors such vision camera to recognize landmarks or QR/Bar codes, ambient light sensor, gyroscope or magnetic compass sensor to direct its functionality and provide viewers with visuals that pertain to them. Further, additional situational response may be directed from wireless radio control or wireless communication methods.

The disclosed systems and method may use data gathered from the GNSS and IMU to determine what images should be displayed. An IMU provides a digital-output of the momentary magnetic field strength in X, Y-Axis (for 2D sensor) and X, Y, Z-Axis (for 3D sensor) vector components. The three vector-components, Mₓ, M_{y}, and M_{z}, respectively in the Cartesian coordinates, may be used to determine the circular cylindrical coordinate system equivalents which are ρ, φ, and z. Mₓ, M_{y}, and M_{z} may also be used to determine a spherical coordinate system using transformation equations to find r, φ, and θ.

Therefore, depending on the situation in which the mobile UAS is being used, the disclosed systems and method may use either of these three coordinate systems, whichever is most suitable for the given situation. Further, the variables may be used to determine the coordinates and the current orientation of the mobile UAS, as well as a mathematical representation of the possible orientations and directions surrounding it.

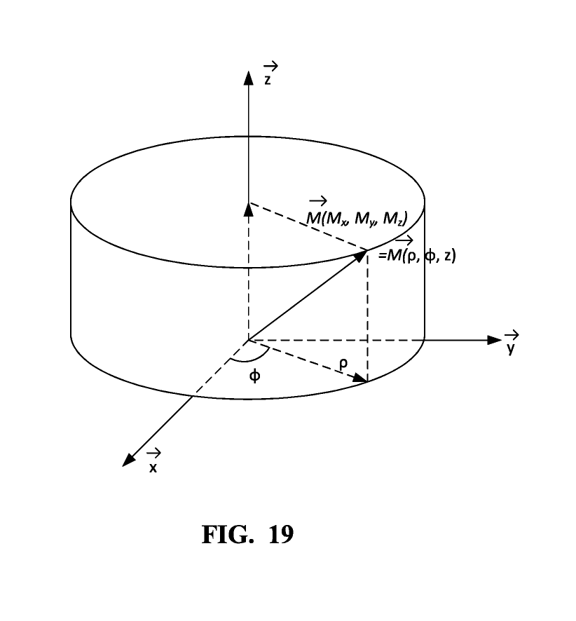

FIG. 19 is a perspective view of a cylindrical coordinate system, where a viewing area may be defined with cylindrical coordinates. As shown in FIG. 19, an orientation of the mobile UAS is determined as a 3D orientation vector calculated from three axes magnetic field vector \vec{M}(Mₓ, M_{y}, M_{z}) in x, y, z coordinates which may be equally represented in 3D cylindrical coordinate vector \vec{M}(ρ,ϕ, z), according to the following transformation equations.

$$\vec{M} ( {M}_{x} , {M}_{y} , {M}_{z} ) = \vec{M} ( ρ , φ , z )$$

$$z = {M}_{z}$$

$$ρ = \sqrt{{M}_{x}^{2} + {M}_{y}^{2}}$$

$$cos φ = \frac{{M}_{x}}{ρ}$$

$$sin φ = \frac{{M}_{y}}{ρ}$$

$$tan φ = \frac{{M}_{y}}{{M}_{x}}$$

$$φ = arctan \frac{{M}_{y}}{{M}_{x}}$$

Further, the position of mobile UAS is determined by GNSS, and the angle ϕ from an IMU magnetic sensor may be used to represent at which point the visual displayed may be changed. A 360° cylinder may be defined around the IMU. Thereafter, the computer of the mobile UAS determine at what degree of rotation (ranging from zero to three-hundred-sixty) visuals are displayed.

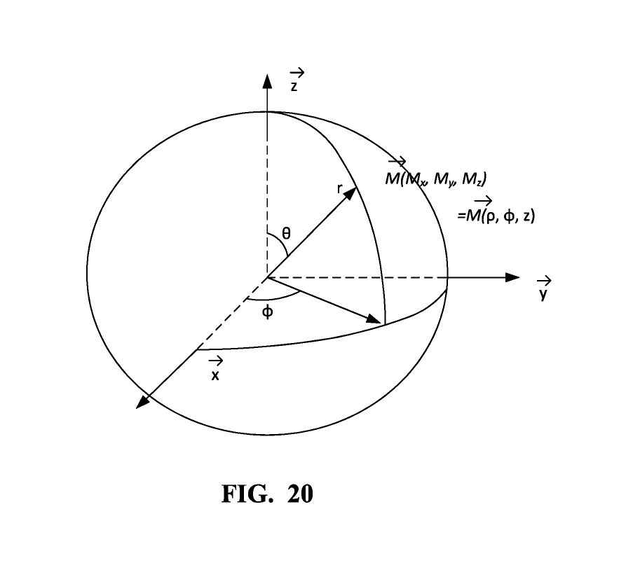

FIG. 20 is a perspective view of a spherical coordinate system, where a viewing area may be defined with spherical coordinates. In spherical coordinate system, the symbol r denotes the distance from the origin to the coordinate where r≥0. φ is the angle between the positive x-axis and the line r, which lies on the x, y plane. θ is the angle between positive z-axis and the line from the origin to the point, where 0<θ<π. The orientation of the mobile UAS, display unit, and viewing area are determined from the following equations.

\vec{M}(Mₓ,M_{y},M_{z})=\vec{M}(r,φ,θ)

r=\sqrt{Mₓ²+M_{y}²+M_{z}²}

Mₓ=r cos φ sin θ

M_{y}=r sin φ sin θ

M_{z}=r cos θ

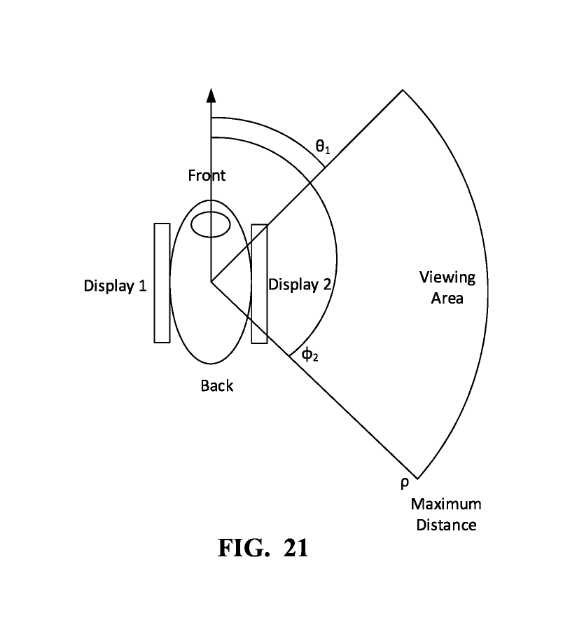

FIG. 21 is a top view of an exemplary viewing area which is defined with cylindrical coordinates in accordance with an exemplary embodiment. Using the cylindrical or spherical coordinate system, the viewing angle may be easily described using the equation below.

0<ρ<Maximum Distance, ϕ₁<ϕ<ϕ₂

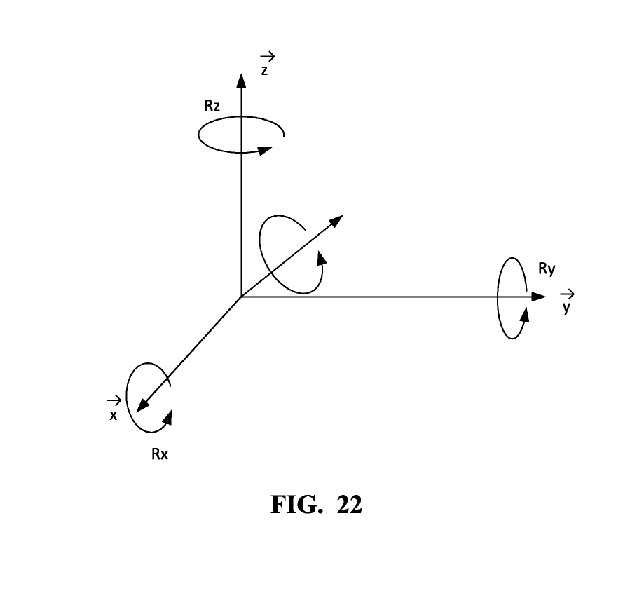

FIG. 22 is a perspective view of a general rotation of the mobile UAS in 3-dimension measured by three gyroscopic sensors in x, y, z direction of the IMU. A gyroscope provides rotation vectors in 1D, 2D, or 3D format such as (Rₓ, R_{y}, R_{z}). R_{z} refers to a clockwise rotation along the z-axis. Further, an IMU chip with 2D or 3D gyroscope sensor may determine the change of orientation of the mobile UAS and displays from the initial start-up status.

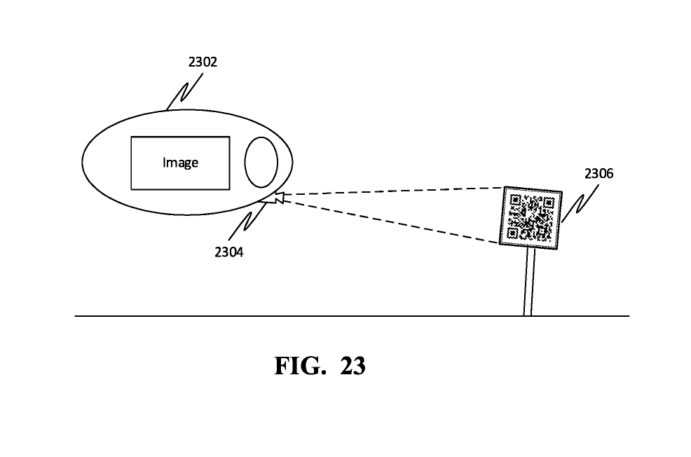

FIG. 23 is a side view of a mobile UAS 2302 mounted camera 2304 reading a QR code (or bar code) 2306 on the ground in accordance with an exemplary embodiment. The camera 2304 may be a machine vision camera. The mobile UAS 2302 may fly to approach an audience. Similarly, recognition of landmarks, terrain mapping data may be used as well.

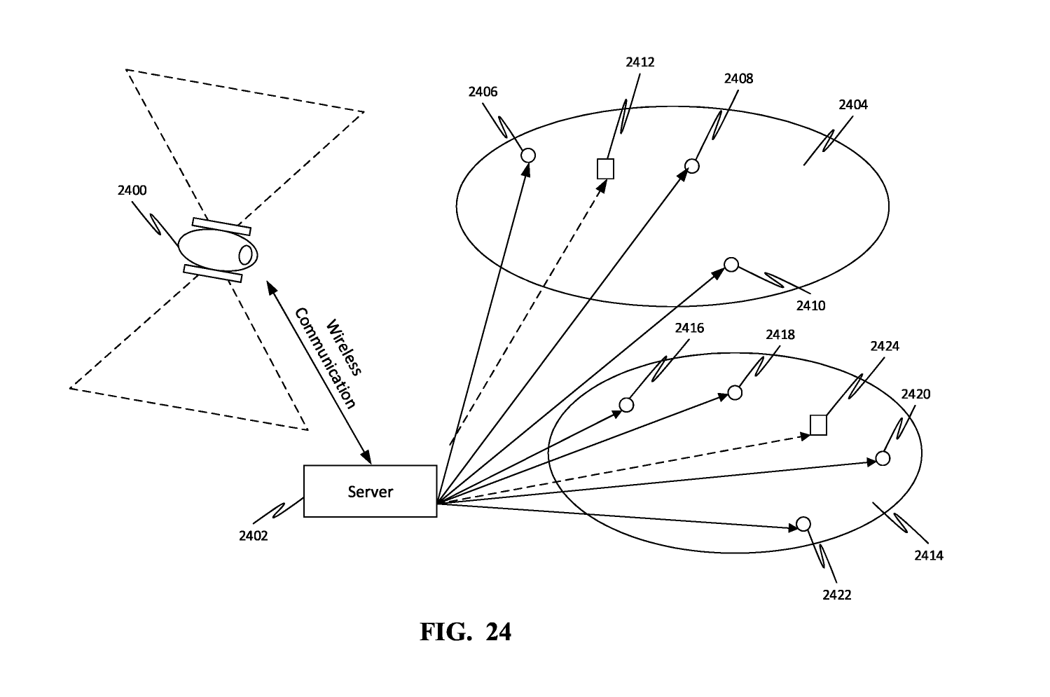

FIG. 24 is a top view of a mobile UAS 2400 communicating with a server 2402 (such as the centralized server 102) on the ground to determine the averaged central position of each group of audiences measured by sum of each position of audience using each individual's smartphone application GPS reading. The audience point may be obtained from preprogrammed values, or it may be dynamically updated from the server 2402 on the ground or onboard by collecting the position of each individual in the audience, who has an application installed on her smartphones (or other devices such as wearable devices). The application may update the position and desired contents, photos, or videos to be displayed on the display of the mobile UAS 2400. Accordingly, the mobile UAS 2400 may change its flight path and display contents received from the server 2402.

For multiple audiences in multiple groups, mean average position of each group may be obtained using equation 9 below.

$$\vec{{A}_{m}} = \frac{{Σ}_{\begin{matrix}i = all audience \\ in the group A\end{matrix}} \vec{{A}_{l}}}{\# of audiences in group A} \qquad [ 9 ]$$

wherein, Aᵢ refers to location of an audience member in a group A, and
Aₘ is the mean average position.

Accordingly, an audience 2404 may include individuals 2406-2410. Thereafter, using the equation 9 above, mean average position 2412 of the audience 2404 may be determined.

Similarly, an audience 2414 may include individuals 2416-2422. Thereafter, using the equation 9 above, mean average position 2424 of the audience 2414 may be determined.

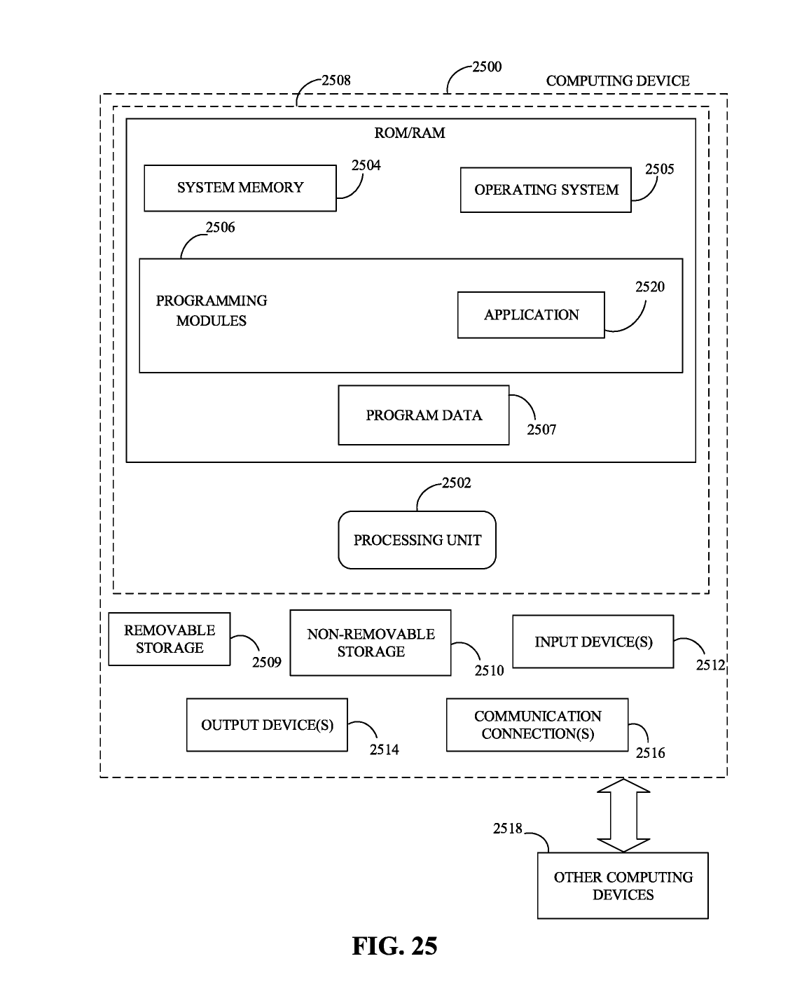

With reference to FIG. 25, a system consistent with an embodiment of the disclosure may include a computing device or cloud service, such as computing device 2500. In a basic configuration, computing device 2500 may include at least one processing unit 2502 and a system memory 2504. Depending on the configuration and type of computing device, system memory 2504 may comprise, but is not limited to, volatile (e.g. random-access memory (RAM)), non-volatile (e.g. read-only memory (ROM)), flash memory, or any combination. System memory 2504 may include operating system 2505, one or more programming modules 2506, and may include a program data 2507. Operating system 2505, for example, may be suitable for controlling computing device 2500′s operation. In one embodiment, programming modules 2506 may include machine learning module. Furthermore, embodiments of the disclosure may be practiced in conjunction with a graphics library, other operating systems, or any other application program and is not limited to any particular application or system. This basic configuration is illustrated in FIG. 25 by those components within a dashed line 2508.

Computing device 2500 may have additional features or functionality. For example, computing device 2500 may also include additional data storage devices (removable and/or non-removable) such as, for example, magnetic disks, optical disks, or tape. Such additional storage is illustrated in FIG. 25 by a removable storage 2509 and a non-removable storage 2510. Computer storage media may include volatile and nonvolatile, removable and non-removable media implemented in any method or technology for storage of information, such as computer-readable instructions, data structures, program modules, or other data. System memory 2504, removable storage 2509, and non-removable storage 2510 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which may be used to store information and which may be accessed by computing device 2500. Any such computer storage media may be part of device 2500. Computing device 2500 may also have input device(s) 2512 such as a keyboard, a mouse, a pen, a sound input device, a touch input device, a location sensor, a camera, a biometric sensor, etc. Output device(s) 2514 such as a display, speakers, a printer, etc. may also be included. The aforementioned devices are examples and others may be used.

Computing device 2500 may also contain a communication connection 2516 that may allow device 2500 to communicate with other computing devices 2518, such as over a network in a distributed computing environment, for example, an intranet or the Internet. Communication connection 2516 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 2504, including operating system 2505. While executing on processing unit 2502, programming modules 2506 (e.g., application 2520 such as a media player) may perform processes including, for example, one or more stages of methods, algorithms, systems, applications, servers, databases as described above. The aforementioned process is an example, and processing unit 2502 may perform other processes. Other programming modules that may be used in accordance with embodiments of the present disclosure may include data processing application, machine learning application, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the disclosure has been explained in relation to its preferred embodiment, it is to be understood that many other possible modifications and variations can be made without departing from the spirit and scope of the disclosure.

We claim:

1. A contextual presentation system comprising:
at least one connection to an on-board display device configured for presenting the at least one presentation content based on the analyzing context-determining data, wherein the at least one on-board display device is communicatively coupled to a processing device;
a storage device configured for storing each of the at least one presentation content, at least one audience position and at least presentation criteria that determines viewing area of display;
at least one of geo-spatial, geo-imaging and angular orientation sensor configured for sensing the at least one context-determining data associated with the contextual presentation system;
a processing device communicatively coupled with each of the display device, the at least one connection, the storage device and the at least one of geo-spatial, geo-imaging and angular orientation sensor, wherein the processing device is configured for analyzing the at least one context-determining data and checking whether the sensor data meets the at least one presentation criteria for viewing area; and
an optional communication device, wherein the communication device is configured for receiving and sending the at least one presentation content from or to an external content providing device or at least one audience position, interactive content and characteristic data via a server or direct wireless connection to the audience's location sensing device.

2. The contextual presentation system of claim 1 being mounted on an unmanned aerial system (UAS) that includes multi-copter drone, fixed wing unmanned aerial vehicle (UAV), rotary wing UAV, unmanned airship and motorized tethered or free flying blimp, wherein the display system which is connected to the presentation system is also mounted on the UAS.

3. The contextual presentation system of claim 1, wherein the at least one presentation criteria are determined by checking whether at least one audience position is within a viewing area calculated from the position and angular orientation of UAS and its display devices.

4. The contextual presentation system of claim 1 further comprising a flight control unit communicatively coupled to the processing device, wherein the processing device is further configured for controlling operation of the UAS based on the analyzing of at least one of geo-spatial and geo-imaging data.

5. The contextual presentation of claim 1, wherein the processing device is further configured for controlling at least one of a position, an orientation, a speed, a velocity, an acceleration and a flight path of the UAS in relation to an intended audience point.

6. The contextual presentation system of claim 1 being mounted on an unmanned aerial system, wherein the context-determining data comprises at least one combination of a position and an orientation of the vehicle with respect to a current way-point associated with a trajectory of the vehicle and a distance travelled by the vehicle from a reference location.

7. The contextual presentation system of claim 1, wherein the at least one sensor comprises a location sensor configured for detecting a geographical location of the contextual presentation system and an orientation sensor configured for detecting an orientation of the contextual presentation system in relation to a reference audience point, wherein the geo-spatial sensor comprises at least one of Ground Station Mobile (GSM) or CDMA location sensing and Global Navigation Satellite System (GNSS) location sensing such as GPS, GLONASS, Galileo and Beidou positing system, wherein the geo-imaging sensor comprises at least one of LIDAR, Photogrammetry, object recognizing machine vision camera and QR/Bar code camera.

8. The contextual presentation system of claim 1, wherein the at least one sensor comprises a motion detector configured to detect motion of the contextual presentation system.

9. The contextual presentation system of claim 1, wherein the at least one sensor is configured for sensing at least one environmental variable associated with an environment surrounding the contextual presentation system.

10. The contextual presentation system of claim 1, wherein the at least one sensor comprises an image capturing device configured for capturing an image, wherein the processing device is configured for detecting at least one audience position object represented in the image such as a bar code or QR code.

11. The contextual presentation system of claim 10, wherein the at least one object comprises a plurality of audience individuals, wherein the processing device is further configured for detecting a population size associated with the plurality of audience individuals.

12. The contextual presentation system of claim 10, wherein the processing device is configured for detecting at least one demographic characteristic associated with the plurality of individuals.

13. The contextual presentation system of claim 10, wherein the at least one sensor comprises a distance sensor configured to measure a distance between the contextual presentation system and the plurality of individuals.

14. The contextual presentation system of claim 1, wherein the at least one communication device that receives static or dynamically changing positions and characteristic data from plurality of audience individual's location devices such as smart phones or wearable devices running an app via a server or direct communication to the contextual presentation system.

15. The contextual presentation system of claim 14, wherein the at least one object comprises a plurality of audience individuals, wherein the processing device is further configured for detecting a population size associated with the plurality of audience individuals.

16. The contextual presentation system of claim 14, wherein the at least one object comprises a plurality of audience individuals, wherein the communication device sends dynamic displaying contents, on-board camera image or audio data to audience individuals' smart phones, portable TV, radio or wearable devices.

17. The contextual presentation system of claim 1, wherein the processing device is configured for determining at least one presentation region based on the analyzing of prestored position data of audiences.

18. The contextual presentation system of claim 17, wherein the processing device is configured for determining presence or absence of an audience individual or group within the at least one presentation region.

19. The contextual presentation system of claim 17, wherein the processing device is configured for deactivating the at least one presentation device based on the absence of an audience individual or group within the at least one presentation region.

20. The contextual presentation system of claim 1, wherein the at least one presentation device comprises a plurality of presentation devices configured for presenting a plurality of presentation content to a plurality of presentation regions based on the sensor data of position, orientation, and/or image wherein a first presentation device of the plurality of presentation devices is configured for presenting a first presentation content consumable in a first presentation region, wherein a second presentation device of the plurality of presentation devices is configured for presenting a second presentation content consumable in a second presentation region, wherein the first presentation content is dissimilar to the second presentation content.

21. The contextual presentation system of claim 1 further comprising at least one display actuator or UAS's angular attitude controller communicatively coupled to the processing device, wherein the at least one actuator is configured for changing at least one of a position and an orientation of the at least one presentation display device in relation to a reference point based on the analyzing the orientation of display device to the audience point.

22. The contextual presentation system of claim 1 further comprising at least one presentation criteria with multiple viewing areas that changes contents of the presentation such as sizes and contents of logo, image, video, color, and font.

23. An aerial, ground, or water vehicle mounted contextual presentation system comprising:
an unmanned aerial system configured for providing locomotion to the contextual presentation system;
a storage device configured to store each of at least one presentation content and at least one presentation criteria;
at least one sensor configured for sensing at least one contextual data, wherein the contextual data comprises at least one of a position of the vehicle, an orientation of the vehicle, a current way-point associated with a trajectory of the vehicle and a distance travelled by the vehicle from a reference location;
a processing device communicatively coupled with each of the storage device and the at least one sensor, wherein the processing device is configured for analyzing the at least one contextual data and the at least one presentation criteria; and
at least one on-board presentation display device configured for presenting the at least one presentation content based on the analyzing sensors to check whether location and angular orientation data satisfies the criteria of presentation viewing area, wherein the at least one presentation device is communicatively coupled to the processing device; and
an optional communication device, wherein the communication device is configured for receiving and sending the at least one presentation content from or to an external content providing device or at least one audience position, interactive content and characteristic data via a server or direct wireless connection to the audience's location sensing device.
